(19) United States
(12) Patent Application Publication
(10) Pub. No.: US 2025/0095406 A1
(43) Pub. Date: Mar. 20, 2025

(54) Continuous Personalization of Face Authentication

(71) Applicant: Google LLC, Mountain View, CA (US)

(72) Inventors: Cem Kemal Hamami, Seattle, WA (US); Philip Andrew Mansfield, Penticton (CA); Samuel Paradis, Sunol, CA (US); Michael Williams, Sunnyvale, CA (US); Wen-Sheng Chu, San Jose, CA (US)

(73) Assignee: Google LLC, Mountain View, CA (US)

(21) Appl. No.: 18/970,431

(22) Filed: Dec. 5, 2024

Related U.S. Application Data
(60) Provisional application No. 63/726,789, filed on Dec. 2, 2024.

(51) Int. Cl. G06V 40/50; G06V 10/762; G06V 40/16

(52) U.S. Cl. CPC G06V 40/50; G06V 10/762; G06V 40/168; G06V 40/172

(57) ABSTRACT

This document describes systems and techniques that enable continuous personalization of face authentication. In aspects, an authentication system associated with a network includes an authentication manager. The authentication manager receives an embedding representing image data associated with a user's face. The authentication manager generates a confidence score based on the embedding. Further, the authentication manager updates previously enrolled embeddings with the embedding based on the confidence score, the embedding meeting a clustering confidence threshold. Through such a technique, the authentication manager can alter the previously enrolled embeddings by which a future embedding is used to authenticate the user's face. By so doing, the techniques may provide more-accurate and successful user authentication over time.

### CROSS-REFERENCE TO RELATED APPLICATION(S)

This application claims the benefit of U.S. Provisional Patent Application Ser. No. 63/726,789, filed on Dec. 2, 2024, the disclosure of which is incorporated by reference herein in its entirety.

### SUMMARY

This document describes systems and techniques that enable continuous personalization of face authentication. In aspects, an authentication system associated with a network includes an authentication manager. The authentication manager receives an embedding representing image data associated with a user's face. The authentication manager generates a confidence score based on the embedding. Further, the authentication manager updates previously enrolled embeddings with the embedding based on the confidence score, the embedding meeting a clustering confidence threshold. Through such a technique, the authentication manager can alter the previously enrolled embeddings by which a future embedding is used to authenticate the user's face. By so doing, the techniques may provide more-accurate and successful user authentication over time.

This Summary is provided to introduce simplified concepts concerning continuous personalization of face authentication, as further described below in the Detailed Description and Drawings. This Summary is not intended to identify essential features of the claimed subject matter, nor is it intended for use in determining the scope of the claimed subject matter.

### BRIEF DESCRIPTION OF THE DRAWINGS

The details of one or more aspects of continuous personalization of face authentication are described in this document with reference to the following Drawings. The same numbers are used throughout the drawings to reference like features and components.

FIG. 1 illustrates an example operating environment in which techniques for continuous personalization of face authentication can be implemented;

FIG. 2 illustrates an example implementation of the user device of FIG. 1 directed towards continuous personalization of face authentication;

FIG. 3 illustrates an example implementation of an enrollment process used to create enrolled embeddings;

FIG. 4 illustrates an example implementation of the increase in accuracy over time from updating a cluster algorithm with new embeddings; and

FIG. 5 illustrates an example method for continuous personalization of face authentication in accordance with one or more implementations.

### DETAILED DESCRIPTION

### Overview

Many electronic devices, such as smartphones or other computing devices, include light sources and cameras or other sensors utilized to perform image analysis and recognition. For example, some devices use facial recognition to authenticate a user to access the device or to access information on the device. To facilitate facial recognition, some of these devices incorporate a facial recognition machine-learned model (e.g., FaceNet™) to create embeddings from image data associated with a user. These embeddings are vector encodings of information used for facial recognition (e.g., facial features) and are saved during a user's enrollment process to authenticate the same user when they want to access their device.

However, the use of a static enrollment process may lead to an accuracy decrease of recognizing the user over time (e.g., the user's appearance changes or sensors of the device age). Initial enrollment data may have limited information on the user's current appearance (e.g., with glasses, hats, beards), which may result in unsuccessful authentication attempts.

Some electronic devices update previously enrolled embeddings with new embeddings from successful authentication attempts. However, due to limited memory constraints, these electronic devices often store the embeddings from the most-recent successful authentication attempts and delete the oldest embeddings. This may lead to inaccurate facial recognition resulting in failed authentication attempts or a breach of privacy.

Techniques described herein enable an electronic device to use a continuous updating authentication system to build a personalized memory of a user's face. For example, an electronic device can leverage a clustering algorithm to categorize and store an embedding based on information from successful user authentication attempts. The clustering algorithm identifies different groups of embeddings based on features from the user's face and groups similar embeddings into clusters. A statistical confidence distribution is computed for each group, which may provide a more-accurate estimate of the user's face as the clustering algorithm receives more image data. For example, the electronic device can send image data (e.g., embeddings) for the clustering algorithm to group and store on the electronic device. The clustering algorithm can group image data based on distances between the eyes, nose, and mouth which can form a unique model of a user's face. The clustering algorithm can also group features like a beard or eyeglasses into separate clusters. When a new embedding is sent, the clustering algorithm can assign the new embedding to an existing cluster or may start a new cluster if the new embedding is distinctly different than any existing clusters. The new embedding may pass several quality checks before being sent to the clustering algorithm. For example, the image data used to create the new embedding may involve good lighting, low blur, low noise, or low distortion, as examples. In another example, the face pose of the user in the image data may involve a highly frontal pose to ensure continual accuracy of authentication. The new embedding may also successfully authenticate against a current enrollment within the electronic device before being sent to the clustering algorithm. By so doing, the authentication system can update a user's original enrollment with high quality image data and prevent the degradation of the quality of enrollment without the clustering algorithm misidentifying a user.

### Operating Environment

The following discussion describes an operating environment, techniques that may be employed in the operating environment, and various devices or systems in which components of the operating environment can be embodied. In the context of the present disclosure, reference is made to the operating environment by way of example only.

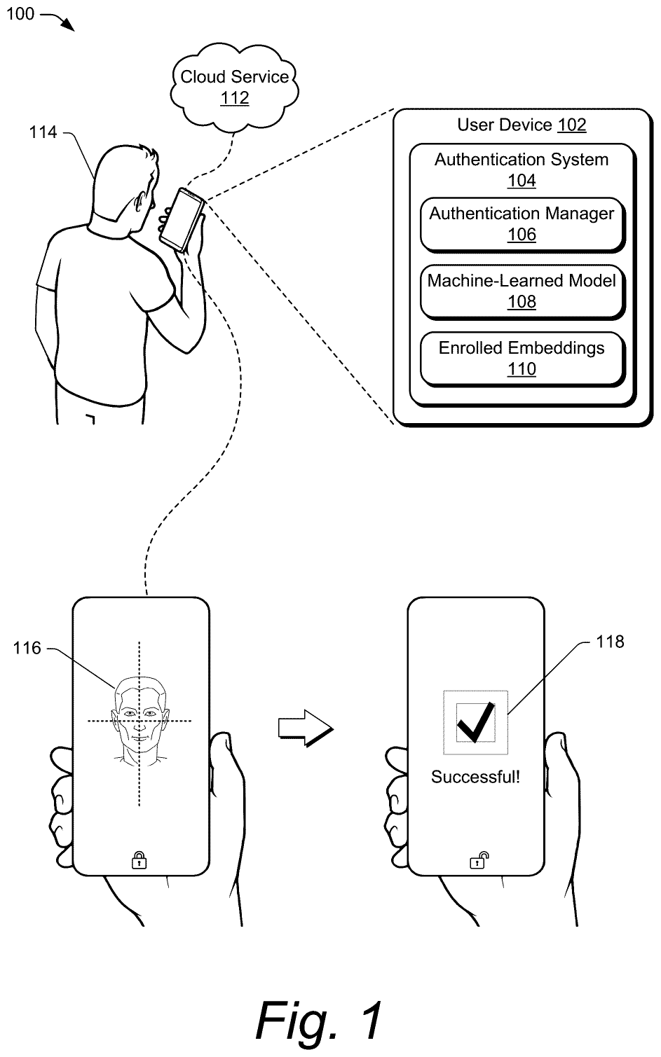

FIG. 1 illustrates an example operating environment 100 in which techniques for continuous personalization of face authentication can be implemented. The example operating environment 100 includes a user device 102 (e.g., an electronic device), which includes, or is associated with, an authentication system 104, an authentication manager 106, a machine-learned model 108, enrolled embeddings 110, and a cloud service 112.

The authentication manager 106 is configured to use the machine-learned model 108 (e.g., clustering algorithm, neural network, convolutional neural network), trained using machine-learning techniques, to generate the enrolled embeddings 110. In aspects, the enrolled embeddings 110 include at least five embeddings from image data associated with a user 114. The image data may include features from a face 116 of the user 114. The authentication manager 104 groups the enrolled embeddings 110 into clusters using the machine-learned model 108 (e.g., the clustering algorithm). Each cluster may represent different features of the face 116. For example, one cluster may correspond to glasses that the user 114 wears while another cluster may correspond to a beard that the user 114 is growing.

In implementations, the face 116 may include any other unique identifier or group of unique identifiers of biometric data from a user. For example, this data may include a fingerprint, an iris image, a voice print, a written signature, a walking gate (e.g., picked up by an inertial measurement system in an electronic device), an online activity trail, or any combination of these examples or other examples. In the same way that the machine-learned model 108 (e.g., FaceNet™) may be a neural network trained to convert image data into embeddings, the machine-learned model 108 may be a different neural network or other machine-learned model trained to convert any biometric data or unique identifier of a user into an embedding.

The user 114 may use their face 116 to unlock their user device 102. The authentication manager 106 may receive an embedding when the user 114 presents their face 116 to the user device 102. If the embedding from the face 116 matches into a cluster from the enrolled embeddings 110, the user 114 will have a successful authentication attempt 118 and the embedding will be added to the cluster group of the enrolled embeddings 110.

In some implementations, the machine-learned model 108 (e.g., the clustering algorithm) may generate a confidence score (not illustrated) based on the embedding from the face 116. The machine-learned model 108 may also generate a confidence threshold (not illustrated) based on each cluster of the enrolled embeddings 110. The confidence threshold for each cluster may be based on a statistical confidence distribution, which may provide a more-accurate estimate of the face 116 of the user 114. The statistical confidence distribution may be specifically adapted to high-dimensional embedding spaces.

In further implementations, the machine-learned model 108 may include multiple machine-learned models. For example, a first machine-learned model (e.g., a facial recognition model, FaceNet™) may be trained to adjust embedding proximity by minimizing a distance between embeddings corresponding to a first user and maximizing a distance between embeddings corresponding to a second user. The first machine-learned model may create these embeddings from image data associated with the first user and image data associated with the second user. The embeddings are vector encodings of information used for facial recognition (e.g., facial features). The first machine-learned model may operate independently of a second machine-learned model used for a clustering algorithm.

The second machine-learned model may determine the statistical distribution of embeddings (e.g., vector encodings) produced by the first machine-learned model and may operate as a model of probability distributions (e.g., clusters). Upon receiving a new embedding (e.g., a new vector encoding), the second machine-learned model may update its parametric representation of these probability distributions. The embedding itself (e.g., as a vector encoding) may be discarded to address memory constraints within an electronic device (e.g., user device 102), and may not be reconstructed. However, an embedding may be kept in certain situations, for example, during user enrollment and/or for the enrolled embeddings 110. The parametric representation of the second machine-learned model may include various parameters, including, but not limited to, cluster centers, how spread out each cluster is around its center, a number of points in a cluster, and a net decay of cluster data over time.

The cloud service 112, which may be connected via an external network, may provide services related to and/or using the machine-learned model 108 and/or a clustering algorithm (not illustrated). By way of example, the cloud service 112 can include applications for connecting to the machine-learned model 108 and/or the clustering algorithm, provisioning and updating devices in the network, and so forth. For example, a user 114 can connect the user device 102 to a central server or cloud-computing system for the purposes of communicating information. The data communications can be carried out using any of a variety of custom or standard wireless protocols (e.g., Wi-Fi®, ZigBee® for low power, 6LoWPAN, Thread®, etc.) and/or by using any of a variety of custom or standard wired protocols (CAT6 Ethernet, HomePlug®, and so on).

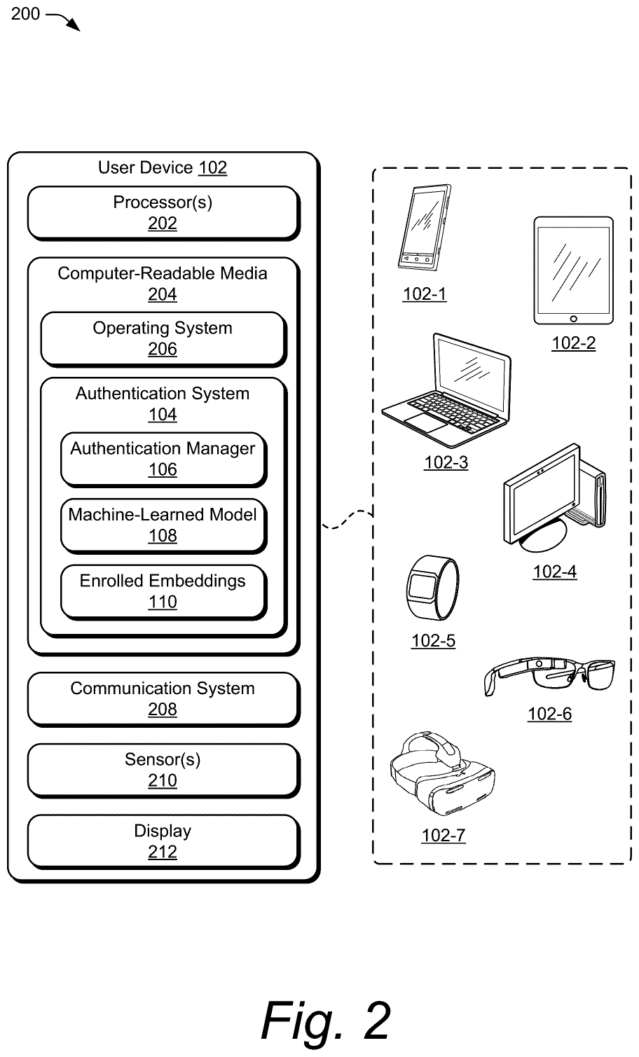

FIG. 2 illustrates an example implementation 200 of the user device 102 that is capable of implementing aspects of continuous personalization of face authentication in accordance with one or more implementations. The user device 102 of FIG. 2 is illustrated with a variety of example devices, including a smartphone 102-1, a tablet 102-2, a laptop 102-3, a desktop computer 102-4, smart-glasses 102-6, and virtual-reality (VR) goggles 102-7. Although not shown, the user device 102 may also be implemented as any of a mobile communication device, a client device, a home automation and control system, an entertainment system, a personal media device, a television, drones, e-readers, track pads, a health monitoring device, a camera, an Internet home appliance capable or wireless Internet access and browsing, an IoT device, security systems, and the like. Note that the user device 102 can be wearable, non-wearable but mobile, or relatively immobile (e.g., desktops, home, and appliances). The user device 102 may include components or interfaces omitted from FIG. 2 for the sake of clarity or visual brevity.

As illustrated, the user device 102 includes one or more processors 202 and computer-readable media 204. The processors 202 may include any suitable single-core or multi-core processor (e.g., an application processor (AP), a digital-signal processor (DSP), a central processing unit (CPU), graphics processing unit (GPU)). The processors 202 may be configured to execute instructions or commands stored within computer-readable media 204. The computer-readable media 204 can include an operating system 206 and the authentication system 104 (e.g., an application). The authentication system 104 includes the authentication manager 106, the machine-learned model 108, and the enrolled embeddings 110. In at least some implementations (not illustrated), the authentication system 104 does not include the machine-learned model 108, and the user device 102 instead accesses a machine-learned model substantially similar to the machine-learned model 108 via the cloud service 112. In other implementations (not illustrated), the authentication system 104 does not include the machine-learned model 108, and the user device 102 instead accesses a clustering algorithm substantially similar to the machine-learned model 108 via the cloud service 112. In still further implementations (not illustrated), the authentication system 104 and/or the authentication manager 106 and/or the machine-learned model 108 can be implemented, partially or completely, on the cloud service 112, the user device 102, and/or any example devices.

Applications (not shown) and/or the operating system 206 implemented as computer-readable instructions on the computer-readable media 204 can be executed by the processors 202 to provide some or all of the functionalities described herein. The computer-readable media 204 may be stored within one or more non-transitory storage devices such as a random access memory (RAM, dynamic RAM (DRAM), non-volatile RAM (NVRAM), or static RAM (SRAM)), read-only memory (ROM), or flash memory), hard drive, solid-state drive (SSD), or any type of media suitable for storing electronic instructions, each coupled with a computer system bus. The term “coupled” may refer to two or more elements that are in direct contact (physically, electrically, magnetically, optically, etc.) or to two or more elements that are not in direct contact with each other, but still cooperate and/or interact with each other.

The user device 102 may further include and/or be operatively coupled to communication systems 208. The communication systems 208 enable communication of device data, such as received data, transmitted data, or other information as described herein, and may provide connectivity to one or more networks and other devices connected therewith. Example communication systems include NFC transceivers, WPAN radios compliant with various IEEE 802.15 (Bluetooth®) standards, WLAN radios compliant with any of the various IEEE 802.11 (WiFi®) standards, WWAN (3GPP-compliant) radios for cellular telephony, wireless metropolitan area network (WMAN) radios compliant with various IEEE 802.16 (WiMAX®) standards, infrared (IR) transceivers compliant with an Infrared Data Association (IrDA) protocol, and wired local area network (LAN) Ethernet transceivers. Device data communicated over the communication systems 208 may be packetized or framed depending on a communication protocol or standard by which the user device 202 is communicating. The communication systems 208 may include wired interfaces, such as Ethernet or fiber-optic interfaces for communication over a local network, a private network, an intranet, or the Internet. Alternatively or additionally, the communication systems 208 may include wireless interfaces that facilitate communication over wireless networks, such as wireless LANs, cellular networks, or WPANs.

The user device 102 may further include and/or be operatively coupled to one or more sensors 210. The sensors 210 can include any of a variety of sensors, such as an audio sensor (e.g., a microphone), a touch-input sensor (e.g., a touchscreen), an image-capture device (e.g., a camera, video-camera), proximity sensors (e.g., capacitive sensors), or an ambient light sensor (e.g., photodetector). In implementations, the user device 102 includes one or more of a front-facing sensor(s) and a rear-facing sensor(s).

The user device 102 may also include a display 212. The display 212 can include any suitable display device, such as a touchscreen, a liquid crystal display (LCD), thin film transistor (TFT) LCD, an in-place switching (IPS) LCD, a capacitive touchscreen display, an organic light emitting diode (OLED) display, an active-matrix organic light-emitting diode (AMOLED) display, super AMOLED display, and so forth.

It will be appreciated by one skilled in the art that components and functions described herein may be further divided and/or combined across one or more network-connected devices, including the user device 102, example user devices 102 and/or the cloud service 112.

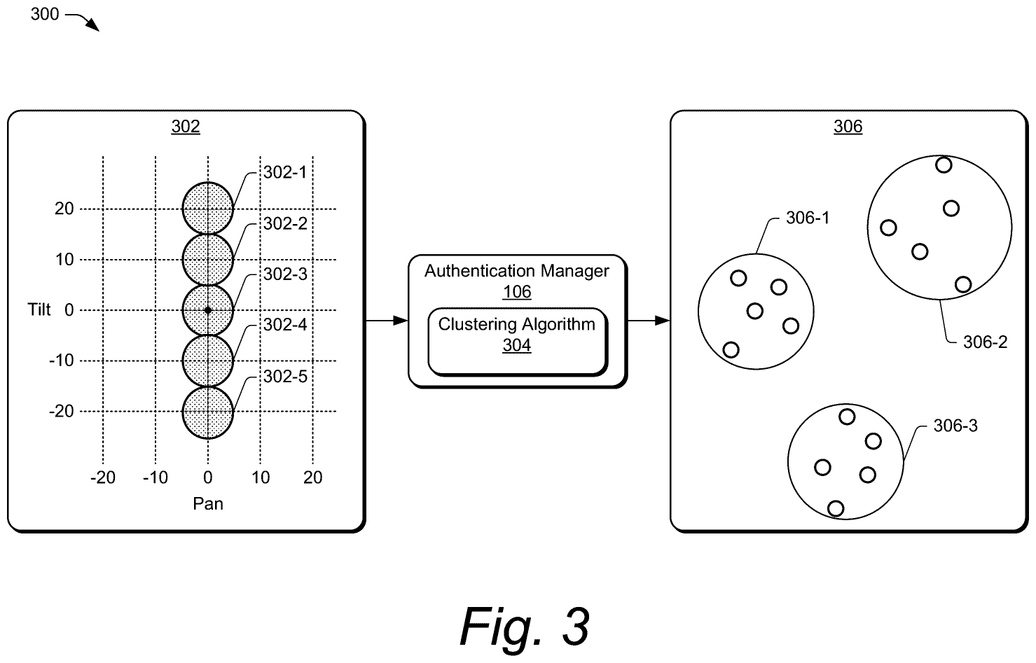

FIG. 3 illustrates an example implementation 300 of the enrollment process used to create enrolled embeddings (e.g., enrolled embeddings 110). As illustrated, the authentication manager 106 receives five face poses 302 (e.g., image data) from a user. The five face poses 302 may have pan and tilt values (pan, tilt) associated with a position of a face and are depicted as circles with a radius of five degrees. For example, a center of a first face pose 302-1 is at (0, 20), a center of a second face pose 302-2 is at (0, 10), a center of a third face pose 302-3 is at (0, 0), a center of a fourth face pose 302-4 is at (0,−10), and a center of a fifth face pose 302-5 is at (0,−20).

Each face pose 302 is received by the authentication manager 106 in the form of an embedding (e.g., n-dimensional vector) and sent to a clustering algorithm 304 (e.g., a machine-learned model). The clustering algorithm 304 outputs the embeddings in clusters 306. The clusters 306 may represent different features of the user (e.g., user 114). For example, a first cluster 306-1 may correspond to a nose piercing, a second cluster 306-2 may correspond to a skin tone, and a third cluster 306-3 may correspond to a hair length.

In implementations, the clustering algorithm 304 may be described through a set of equations. For example, given a set X={xᵢ} of unit length vectors chosen randomly from a cluster (e.g., the first cluster 306-1), the probability distribution of the likelihood of a center value u is described in Equation 1:

$$L ( μ ; X ) = {\prod }_{i} ρ ( {x}_{i} ; μ ) ∝ {e}^{- \frac{{\sum }_{i} {( ∠ ( {x}_{i} , μ ) )}^{2}}{2 {σ}^{2}}} \qquad ( Eq . 1 )$$

where σ is a parameter that affects the spread of the distribution around μ. The clustering algorithm 304 calculates the likelihood of each possible center (e.g., centroid) μ for a set of data points X. The likelihood function in Equation 1 is proportional to an exponential of the sum of squared angular distances. The more likely a center μ is for a given set of X, the more closely it represents an optimal cluster centroid \hat{μ}. To determine the optimal cluster centroid \hat{μ}, the clustering algorithm 304 may utilize an argument of the minimum function seen in Equation 2:

$$\hat{μ} = arg {min}_{μ} {\sum }_{i} {( ∠ ( {x}_{i} , μ ) )}^{2} \qquad ( Eq . 2 )$$

Through Equation 2, the clustering algorithm 304 may find a center μ that minimizes the angular distance to all data points in a cluster to determine the optimal centroid of the cluster. The clustering algorithm 304 may further use a similarity threshold function s(k) in Equation 3:

$$s ( k ) = \frac{k {cos}^{2} {θ}_{c}}{\sqrt{{k}^{2} {cos}^{2} {θ}_{c} + k {sin}^{2} {θ}_{c}}} = \frac{{T}_{c}^{2}}{\sqrt{\frac{1}{k} + ( 1 - \frac{1}{k} ) {T}_{c}^{2}}} \qquad ( Eq . 3 )$$

where k is a number of vectors currently in a cluster and θ_{c} is a constant angle that describes how spread out the cluster is and depends on the distribution of vectors within the cluster. As k increases, the function s (k) approaches a fixed cluster similarity threshold T_{c}, where T_{c}=cosec. The clustering algorithm 304 uses the dynamic function s (k) to determine if a new point (e.g., a new vector, a new embedding) belongs to an existing cluster. The threshold is based on cosine similarity and adapts as more points are added to maintain consistent clustering criteria. If the cosine similarity between the new point and the cluster center exceeds s (k), the new point is added to the cluster.

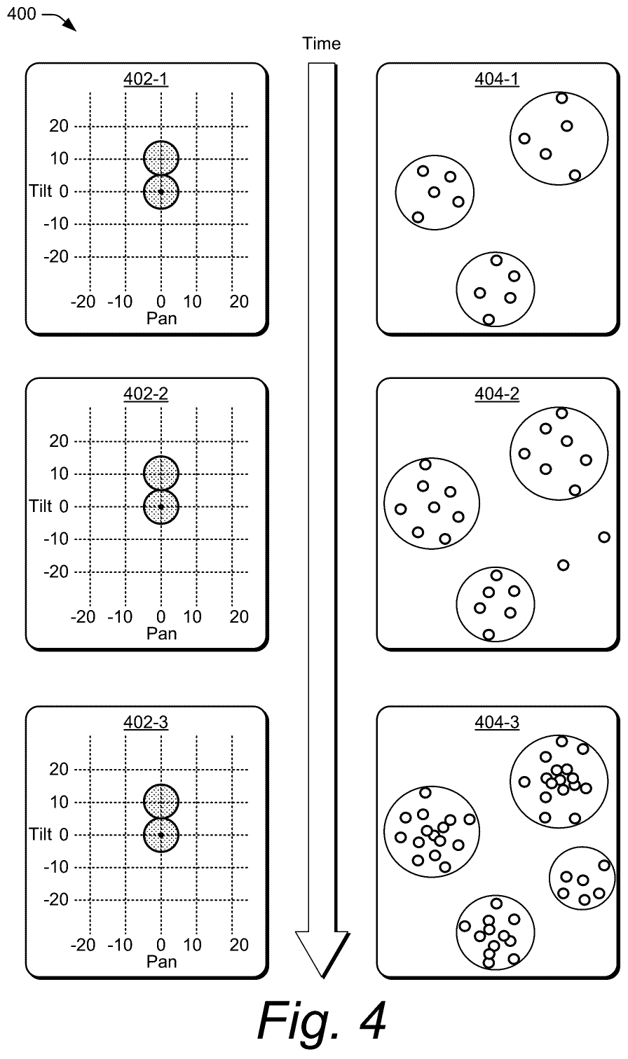

FIG. 4 illustrates an example implementation 400 of an increase in accuracy of face authentication from updating a cluster algorithm with new embeddings over a period of time. The example implementation 400 includes frontal poses 402. To become an embedding used in cluster groupings 404, the frontal poses 402 are within a radius of five degrees from defined regions illustrated in FIG. 4. For example, to pass the criteria to be used as an embedding in continuous and personalized face authentication, the frontal poses 402 are within five degrees from points (0, 0) and (0, 10). This is effectively a highly frontal pose before a user device (e.g., user device 102) and would indicate that a user (e.g., user 114) may face a camera (e.g., sensors 210) in the user device directly.

In implementations, a first frontal pose 402-1 may be the first authentication attempt from a user after successfully finishing an enrollment process (e.g., as seen in FIG. 3). A confidence threshold is calculated from a clustering algorithm (e.g., clustering algorithm 304) based on a statistical confidence distribution from a first cluster grouping 404-1. Once the first frontal pose 402-1 passes the criteria to be used as an embedding, a confidence score is generated from the embedding. An authentication manager (e.g., authentication manager 106) determines, based on the confidence score, to add the embedding to the first cluster group 404-1. In some cases, the authentication manager compares a confidence threshold and the confidence score, and if the confidence score exceeds the confidence threshold, the user is successfully authenticated, and the embedding is added to the first cluster group 404-1.

Over time, a second frontal pose 402-2 may be the eighth successful authentication attempt corresponding to a second cluster grouping 404-2. The second cluster grouping 404-2 may have more data corresponding to each cluster and may also have data that does not correspond to a cluster yet. After even more time, a third frontal pose 402-3 may be the thirty-fourth successful authentication attempt corresponding to a third cluster grouping 404-3. The third cluster grouping 404-3 may have still more data corresponding to each cluster and may have data corresponding to a new cluster.

### Example Methods

The method 500 is shown as a set of blocks that specify operations performed but are not necessarily limited to the order or combinations shown for performing the operations by the respective blocks. Further, any of one or more of the operations may be repeated, combined, reorganized, or linked to provide a wide array of additional and/or alternate methods. In portions of the following discussion, reference may be made to any of the preceding figures or processes as detailed in other figures, reference to which is made for example only. The techniques are not limited to performance by one entity or multiple entities operating on one device.

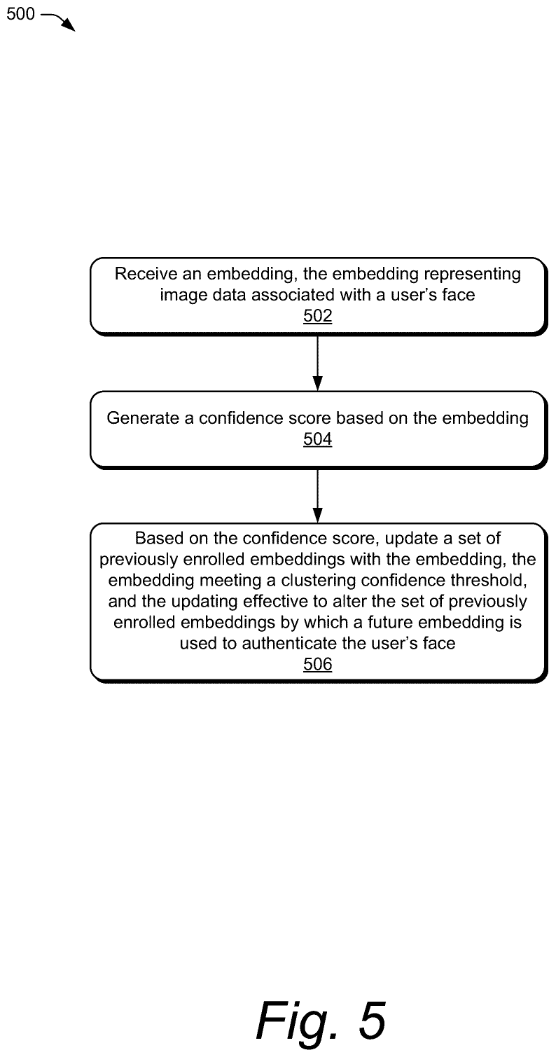

FIG. 5 illustrates an example method 500 for continuous personalization of face authentication in accordance with one or more implementations. At 502, an embedding representing image data associated with a user's face is received. For example, the user 114 from FIG. 1 may present their face 116 to the user device 102.

At 504, a confidence score based on the embedding is generated using a clustering algorithm. For example, the machine-learned model 108 (e.g., the clustering algorithm 304) may generate a confidence score based on an embedding from the face 116.

At 506, previously enrolled embeddings are updated with the embedding based on the confidence score. The updating is effective to alter the previously enrolled embeddings by which a future embedding is used to authenticate the user's face. For example, the authentication manager 106 may update the enrolled embeddings 110 with the embedding from the face 116 based on the confidence score from the machine-learned model 108 (e.g., the clustering algorithm 304).

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Also, as used herein, a phrase referring to “at least one of” a list of items refers to any combination of those items, including single members. For instance, “at least one of a, b, or c” can cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c, or any other ordering of a, b, and c). Further, items represented in the accompanying figures and terms discussed herein may be indicative of one or more items or terms, and thus reference may be made interchangeably to single or plural forms of the items and terms in this written description.

Throughout this disclosure, examples are described where a computing system (e.g., the user device, user equipment, a client device, a server device, a computer, or another type of computing system) may analyze information (e.g., image data associated with a user's face) associated with a user, for example, the face 116 of the user 114 mentioned with respect to FIG. 1. Further to the descriptions above, a user may be provided with controls allowing the user to make an election as to both if and when systems, programs, and/or features described herein may enable collection of information (e.g., information about a user's social network, social actions, social activities, profession, a user's preferences, a user's current location), and if the user is sent content or communications from a server. The computing system can be configured to only use the information after the computing system receives explicit permission from the user of the computing system to use the data. For example, in situations where the user device analyzes image data for facial features to authenticate the user, individual users may be provided with an opportunity to provide input to control whether programs or features of the user device can collect and make use of the data. Further, individual users may have constant control over what programs can or cannot do with the information. In addition, information collected may be pre-treated in one or more ways before it is transferred, stored, or otherwise used, so that personally-identifiable information is removed. For example, before the user device shares image data with another device (e.g., to train a model executing at another device), the user device may pre-treat the image data to ensure that any user-identifying information or device-identifying information embedded in the data is removed. Thus, the user may have control over whether information is collected about the user and the user's device, and how such information, if collected, may be used by the computing device and/or a remote computing system.

### CONCLUSION

Although implementations of systems and techniques for continuous personalization of face authentication have been described in language specific to certain features and/or methods, the subject of the appended claims is not necessarily limited to the specific features or methods described. Rather, the specific features and methods are disclosed as example implementations of systems and techniques for implementing continuous personalization of face authentication.

What is claimed is:

1. A method comprising:
receiving an embedding, the embedding representing image data associated with a user's face;
generating a confidence score based on the embedding; and
based on the confidence score, updating a set of previously enrolled embeddings with the embedding, the embedding meeting a clustering confidence threshold, and the updating effective to alter the set of previously enrolled embeddings by which a future embedding is used to authenticate the user's face.

2. The method of claim 1, wherein the confidence score is generated using a clustering algorithm.

3. The method of claim 2, wherein the clustering algorithm is based on a machine-learned model.

4. The method of claim 2, wherein the clustering algorithm is:
$$\hat{μ} = arg {min}_{μ} {\sum }_{i} {( ∠ ( {x}_{i} , μ ) )}^{2} ,$$
where û is an optimal centroid of a cluster, μ is a potential centroid of a cluster, i is an index of data points in a cluster, and xᵢ is a vector in a cluster.

5. The method of claim 2, wherein generating the confidence score is based on the embedding and the set of previously enrolled embeddings, the set of previously enrolled embeddings grouped into clusters using the clustering algorithm.

6. The method of claim 5, wherein the clusters of the set of previously enrolled embeddings represent different features of the user's face.

7. The method of claim 1, further comprising:
prior to generating the confidence score, determining that the user's face is in a frontal face position, the frontal face position having a pan value and a tilt value.

8. The method of claim 7, wherein the pan value is within a radius of a defined frontal face position and the tilt value is within the radius of the defined frontal face position.

9. The method of claim 7, wherein each enrolled embedding of the set of previously enrolled embeddings comprises an n-dimensional vector representing one or more features of the user's face.

10. The method of claim 1, wherein the set of previously enrolled embeddings include at least five embeddings.

11. An electronic device comprising:
one or more processors; and
a memory storing instructions that, when executed by the one or more processors, cause the one or more processors to:
receive an embedding, the embedding representing image data associated with a user's face;
generate a confidence score based on the embedding; and
based on the confidence score, update a set of previously enrolled embeddings with the embedding, the embedding meeting a clustering confidence threshold, and the update effective to alter the set of previously enrolled embeddings by which a future embedding is used to authenticate the user's face.

12. A non-transitory, computer-readable medium storing instructions that, when executed by one or more processors, cause the one or more processors to:
receive an embedding, the embedding representing image data associated with a user's face;
generate a confidence score based on the embedding; and
based on the confidence score, update a set of previously enrolled embeddings with the embedding, the embedding meeting a clustering confidence threshold, and the update effective to alter the set of previously enrolled embeddings by which a future embedding is used to authenticate the user's face.

13. A computer program product storing instructions that, when executed by one or more processors, cause the one or more processors to:
receive an embedding the embedding representing image data associated with a user's face;
generate a confidence score based on the embedding; and
based on the confidence score, update a set of previously enrolled embeddings with the embedding, the embedding meeting a clustering confidence threshold, and the update effective to alter the set of previously enrolled embeddings by which a future embedding is used to authenticate the user's face.
